(19) United States
(12) Patent Application Publication
(10) Pub. No.: US 2004/0117296 A1
(43) Pub. Date: Jun. 17, 2004

(54) Method and system for pricing and evaluating loans

(76) Inventor: Thomas P. Ellison, Florence, OR (US)

Correspondence Address: Charles A. Mirho, 112 W. 37th St., Vancouver, WA, 98660, US

(21) Appl. No.: 10/319,020

(22) Filed: Dec. 12, 2002

(51) Int. Cl. G06F 17/60

(52) U.S. Cl. 705/38

(57) ABSTRACT

A data processing system stores a definition of a loan restriction that includes at least one loan component value and loan component attribute. The data processing system forms combinations of loan component values and loan component attributes of a loan to evaluate and compares each of the combinations with the loan component value and loan component attribute of the loan restriction. A restriction on the loan to evaluate is identified when the loan component values and loan component attributes of a combination match the loan component value and loan component attribute of the loan restriction.

### FIELD

The invention relates to lending and loan generation.

### BACKGROUND

The modem mortgage lending business makes available a rich variety of loan products. Loans are characterized by attributes such as the principle amount, the interest rate, the term, and up-front costs such as points and fees. The loan's cost to the borrower is typically determined, at least in part, by the lender's cost of funds and the lender's perceived risk in providing the loan to the borrower. Factors in determining the risk to the lender may include: the borrower's credit rating and income, the loan-to-value ratio on the security asset, the nature of the asset for which the loan is advanced (e.g. residential, commercial), and others.

Mortgage lenders may originate loans in different ways. Lenders may employ a agents, mortgage brokers, correspondent lenders, the Internet, and combinations thereof. Lenders may purchase individual or more commonly bulk loan portfolios from other lenders. Each lender prices loans according to their own guidelines. Verifying pricing and evaluating loan application data against guidelines from different lenders is prone to error and can result in errors and delays in identifying suitable loan products for applicants.

Of course, the borrower may, in some circumstances, also be a mortgage lender, broker, correspondent lender, and/or agent.

Often, the borrower will approach a mortgage broker in order to obtain a loan. The mortgage broker may act as a middle man to provide loan products from a variety of lenders. The borrower may provide to the mortgage broker information about the amount of the loan, the property that is the subject of the loan, a ceiling on mortgage and loan costs, and other information relevant to selecting a loan product. The broker may then search the loan offerings from the various lenders for those loans that are suitable to the borrower. Unfortunately, many loans have associated restrictions and add-on costs. The broker may be forced to scan rate sheets from the various lenders and individually determine the impact of restrictions and add-ons to the borrower. The process may be error-prone and may result in delays and/or oversights in identifying suitable loans to the borrower.

### FIGURES

The invention may be better understood with reference to the following figures in light of the accompanying description. The present invention, however, is limited only by the scope of the claims at the concluding portion of the specification.

FIG. 1 is a block diagram of an embodiment of data tables to represent a simple loan restriction.

FIG. 2 is a block diagram of an embodiment of data tables to represent a complex loan restriction.

FIG. 3 is a block diagram of an embodiment of data tables to represent a simple loan add-on.

FIG. 4 is a block diagram of an embodiment of data tables to represent a complex loan add-on.

FIG. 5 is a block diagram of an embodiment of data tables to represent loan attributes and component values.

FIG. 6 is a block diagram of an embodiment of data tables to represent loan attributes and component values.

FIG. 7 is a block diagram of an embodiment of data tables to represent loan attributes and component values.

FIG. 8 is a block diagram of an embodiment of data tables to represent loan attributes and component values.

FIG. 9 is a flow chart of an embodiment of a method to identify simple restrictions that apply to a loan.

FIG. 10 is a flow chart of an embodiment of a method to identify complex restrictions that apply to a loan.

FIG. 11 is a flow chart of an embodiment of a method to identify complex add-ons that apply to a loan.

FIG. 12 is a block diagram of an embodiment of a system for evaluating and pricing loans.

### DESCRIPTION

In the following description, numerous references to “one embodiment” or “an embodiment” do not necessarily refer to the same embodiment, although they may. In the figures, like numbers refer to like elements.

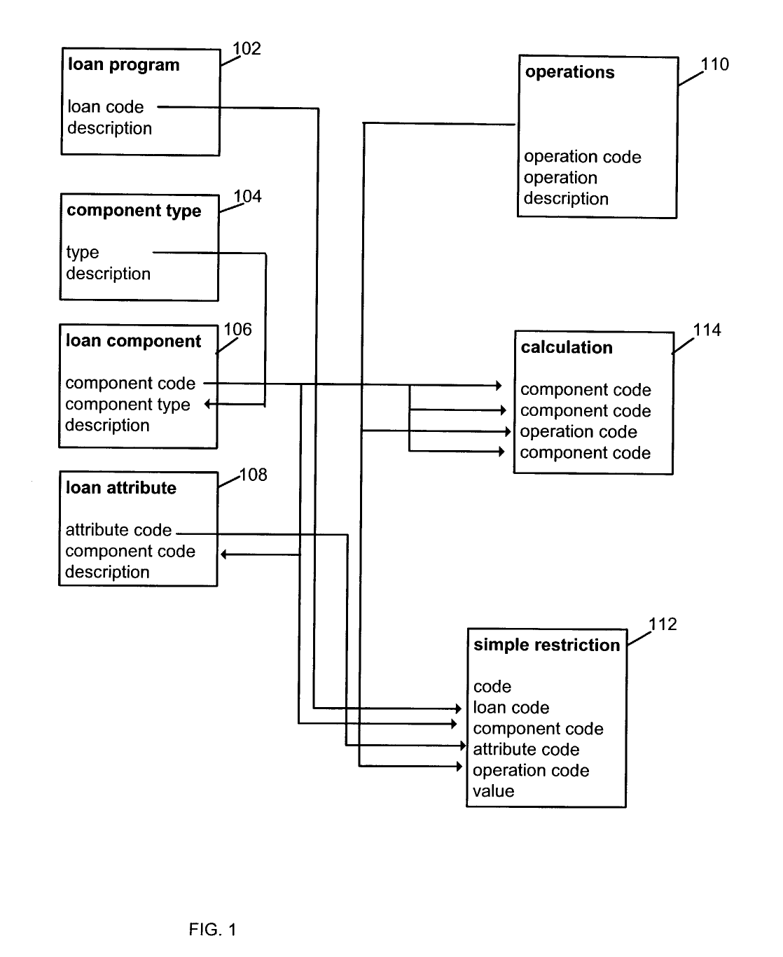

FIG. 1 is a block diagram of an embodiment of data tables to represent loans. Table 102 identifies different loan codes, and includes fields for the loan code (also called the loan program) and a description of the loan code. The loan code may be represented in the table 102 by a numeric code or other identifier. Example loan codes are thirty year fixed, fifteen year fixed, monthly adjustable rate, and six month adjustable rate. Table 104 identifies different loan component types, and includes fields for the component type and a description of the component type. A loan component is a feature of the loan. One example of a component type is a defined component type, e.g. a component that takes a value from one of a set of predefined values. Another example of a component type is an undefined component type, e.g. a component that takes a value that is not predefined. Yet another example of a component type is a calculated component type, e.g. a component whose value is calculated from one or more other component values.

Table 114 defines calculations for calculated component values. The table comprises a first component code to identify the loan component to be calculated. The table further comprises second and third component codes for the operands of the calculation, and an operation code to define the calculation to perform on the second and third loan components. For example, a component called the debt ratio may be defined as the amount of the monthly payment on the loan, divided by the borrower's monthly income. In this case, the second and third component codes would identify the loan components for the monthly payment amount and the borrower's monthly income. The operation code would identify division.

Table 106 describes loan components and includes fields for a component code, a component type, and a description of the component. One example of a defined loan component is the occupancy of the structure that is the subject of the loan—owner occupied, non-owner occupied, second home, etc. One example of an undefined loan component is the loan applicant's credit score. One example of a calculated loan component is the borrower's debt ratio—the amount borrowed divided by the value of the asset to which the loan is applied.

Table 108 describes loan attributes. Loan attributes are the predefined values that defined components may take on. Thus, the occupancy values of owner occupied, non-owner occupied, second home, and so on, are loan attributes. Other examples of loan attributes are possible values for the purpose of the loan—purchase, refinance, and cash-out refinance (other values may also be possible).

Table 110 describes operations to perform when comparing or manipulating loan components and/or attributes. Fields of table 110 include an operation code, the operation itself, and a description of the operation. Operations can be relational or mathematical. Example relational operations include equality, greater than, less than, and so on. Example mathematical operations include addition, subtraction, multiplication, and so on.

Table 112 defines a simple loan restriction. A loan restriction is a condition for a loan to meet. Table 112 includes fields for a code to identify the restriction, the loan code, a component code, an attribute code, an operation code, and a value. Syntactically, a simple loan restriction defined by table 112 may be interpreted as follows:

“For” <attribute> “,” <component> “must be” <operation> “value” e.g., “For non-owner occupied, credit score must be greater than 600”.

The data table embodiments of FIG. 1 are of course only possible ways of organizing the information to represent loans. In other embodiments, tables can have additional fields, and/or fields may be allocated among tables in a different manner than those illustrated. In general, this principle applies to all figures and descriptions of data tables provided herein.

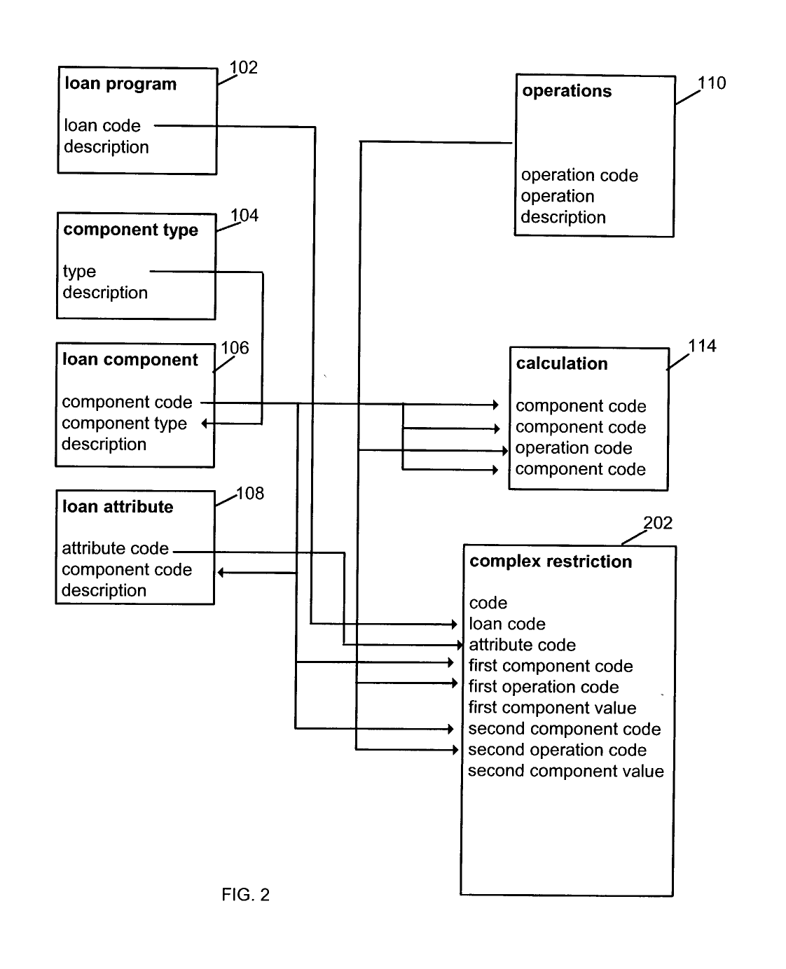

FIG. 2 illustrates an embodiment of a data table 202 to describe a complex loan restriction. Complex loan restrictions resemble simple loan restrictions, but involve more criteria. Fields of table 202 include a restriction code, the loan code, a loan attribute, first and second loan components, first and second operations, and first and second values. Syntactically, a complex loan restriction defined by table 202 may be interpreted as follows:

“For” <attribute> “with” <first component> <first operation> <first value> “,”<second component> “must be” <second operation> <second value>. e.g. “For non-owner occupied with credit score less than 600, LTV must be less than 70.”

Here, LTV is a loan component representing the loan-to-value ratio of the property that is the subject of the loan.

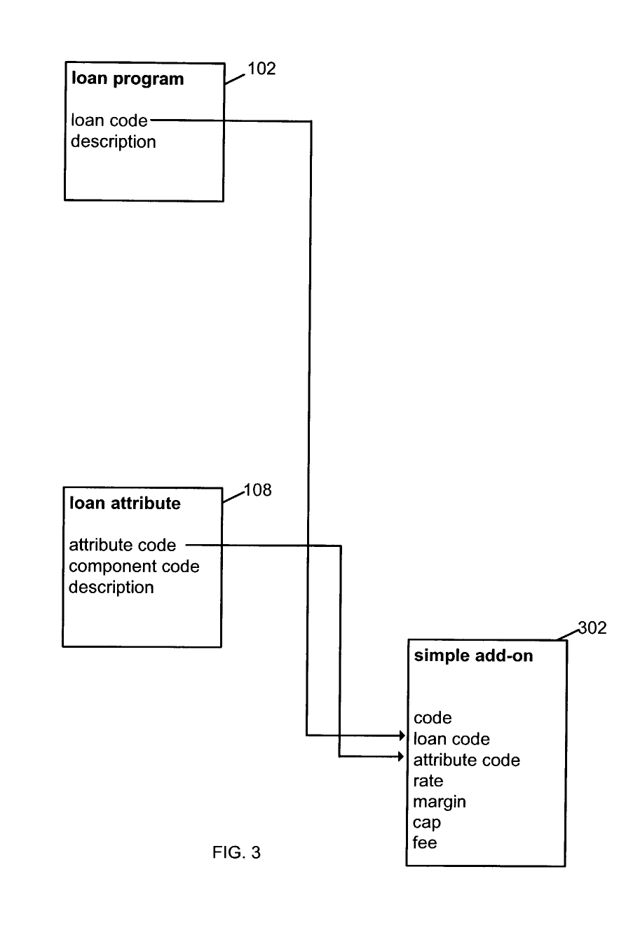

FIG. 3 illustrates a data table embodiment 302 to describe a simple loan add-on. Add-ons are financial adjustments that are applied to the loan when certain conditions are met. Table 302 includes fields for an add-on code, the loan code, a loan attribute, a loan rate, a margin, a cap, and a fee. Syntactically, a simple loan add-on defined by table 302 may be interpreted as follows:

“For” <attribute> “add” <rate> “to rate,” <margin> “to margin,” <cap> “to cap, and” <fee> “to fee” e.g. “For non-owner occupied, add 0.5 to rate, 0.25 to margin, 0.5 to cap, and 0.125 to fee.”

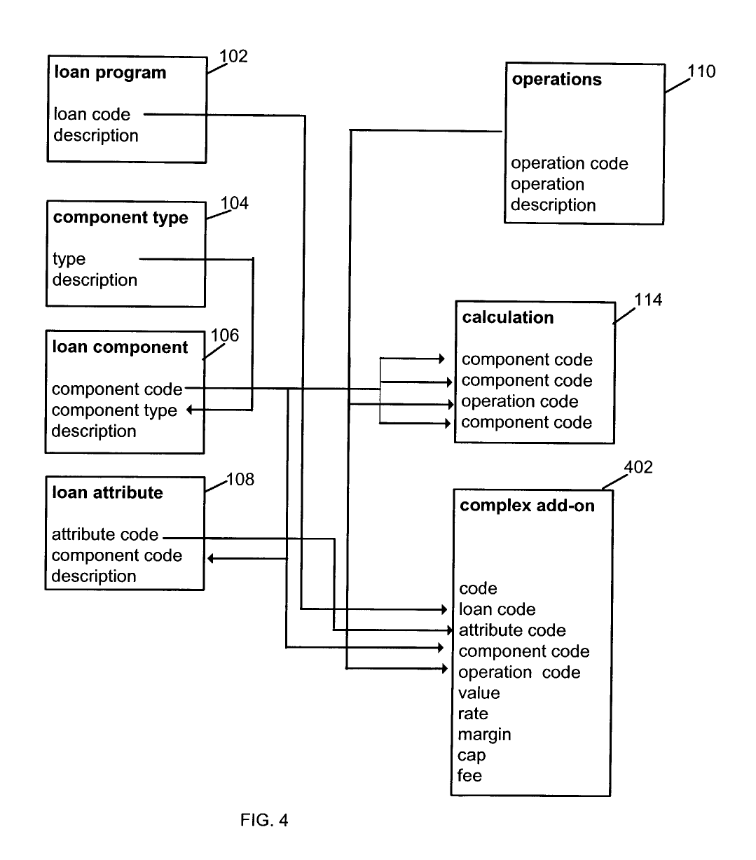

FIG. 4 is a block diagram of a data table embodiment 402 to describe a complex loan add-on. Table 402 includes fields for an add-on code, the loan code, a loan attribute, a loan component, an operation, a value, a loan rate, a margin, a cap, and a fee. Syntactically, a complex loan add-on defined by table 402 may be interpreted as follows:

“For” <attribute> “with” <component> <operation> <value> “add” <rate> “to rate,” <margin> “to margin,” <cap> “to cap, and” <fee> “to fee” e.g. “For non-owner occupied with credit score less than 600, add 0.5 to rate, 0.25 to margin, 0.5 to cap, and 0.125 to fee.”

Those skilled in the art will appreciate that the data tables of FIGS. 1-4 could be extended and/or modified in a straight-forward fashion to describe restrictions and add-ons involving even more criteria.

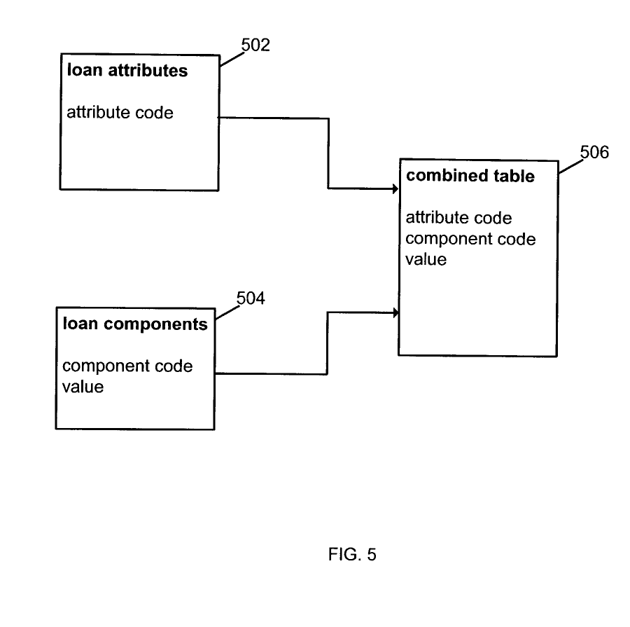

FIG. 5 is a block diagram of data table embodiments to identify loans matching certain criteria. A set of loan attributes is identified in table 502. A set of loan components and associated values is identified in table 504. A combined table 506 is formed from the tables 502, 504. The combined table 506 is produced from the Cartesian product of the tables 502, 504, e.g. table 506 comprises all combinations of the attributes from table 502 with the components and values from table 504.

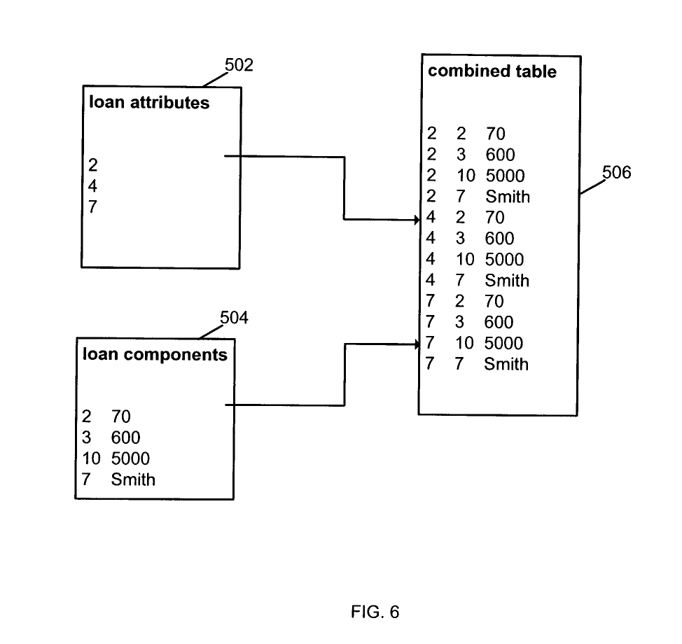

FIG. 6 is a block diagram of the tables of FIG. 5 including exemplary data. The loan attributes of table 502 are combined with the loan components of table 504 as a Cartesian product (e.g. one row for each permutation of the data in the tables) to produce table 506.

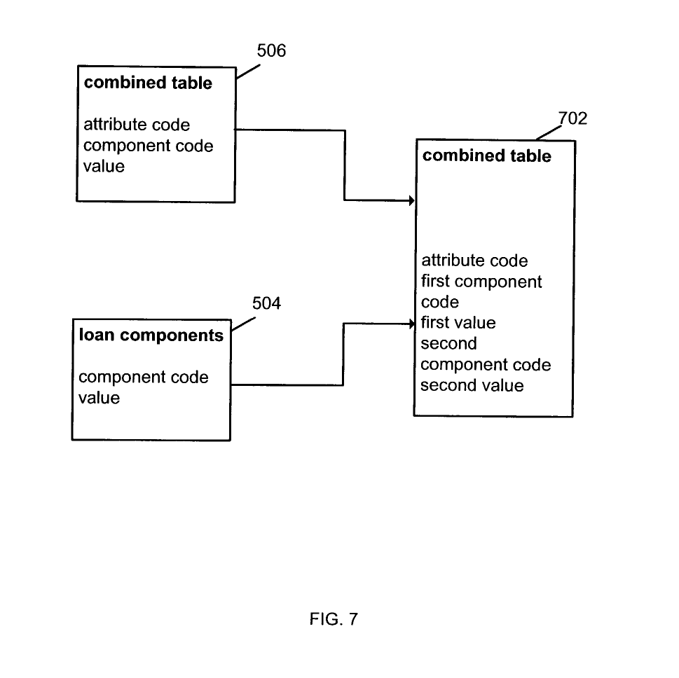

FIG. 7 is a block diagram of data table embodiments to identify loans matching certain criteria. The combined table 506 formed from the tables 502, 504 is further combined with the set of loan components and associated values in table 504. The combined table 702 is produced from the Cartesian product of the tables 506, 504, e.g. table 702 comprises all combinations of the entries from table 506 with the components and values from table 504.

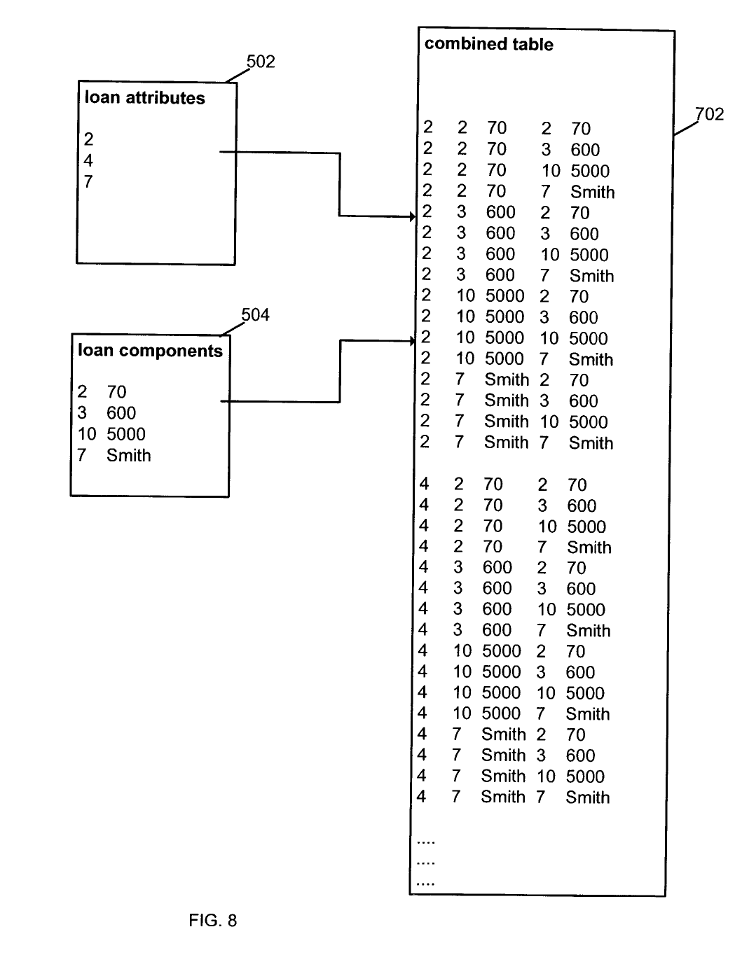

FIG. 8 is a block diagram of the tables of FIG. 7 including exemplary data. The loan attributes of table 502 are combined with the loan components of table 504 as a Cartesian product to produce table 702.

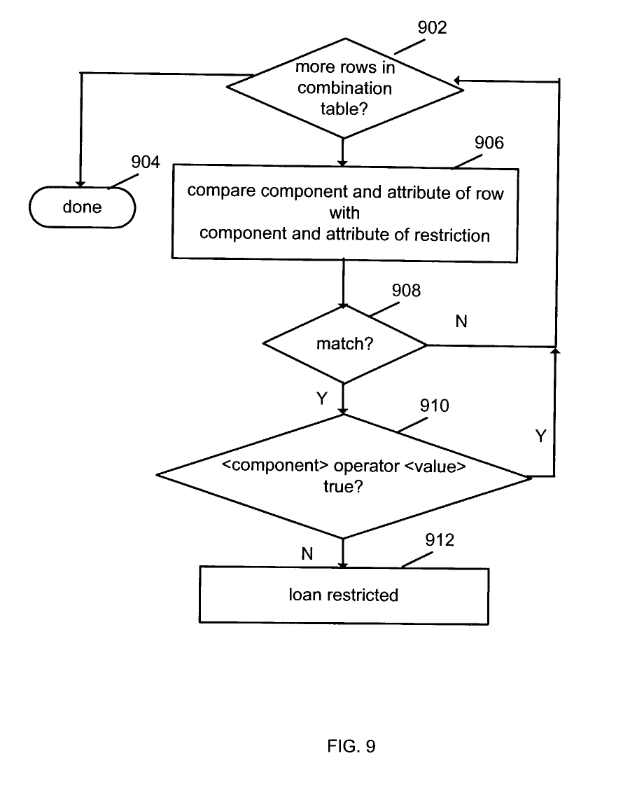

FIG. 9 is a flow chart of a method embodiment to identify loans subject to a simple restriction. At 902 it is determined whether there are more rows to evaluate in the combination table 506. Typically evaluation will begin at the first row of the table 506, but this need not be the case. If there are more rows to evaluate, the component and attribute of the row are compared with the component and attribute of the restriction at 906. If at 908 the components and attributes match, the expression <component value> <restriction operator> <restriction value> is evaluated at 910. Otherwise, the method continues with the next row at 902. If the evaluation is true, the loan is identified as restricted (at 912) according to the restriction. Once there are no more rows to evaluate, the method ends at 904.

The method may be repeated for each restriction identified by table 112 to identify all simple restrictions that apply to a loan having the attributes and component values identified in tables 502 and 504. When a simple restriction is identified as applying to a loan, the simple restriction may be communicated in human-understandable terms by applying the syntax previously described for simple loan restrictions.

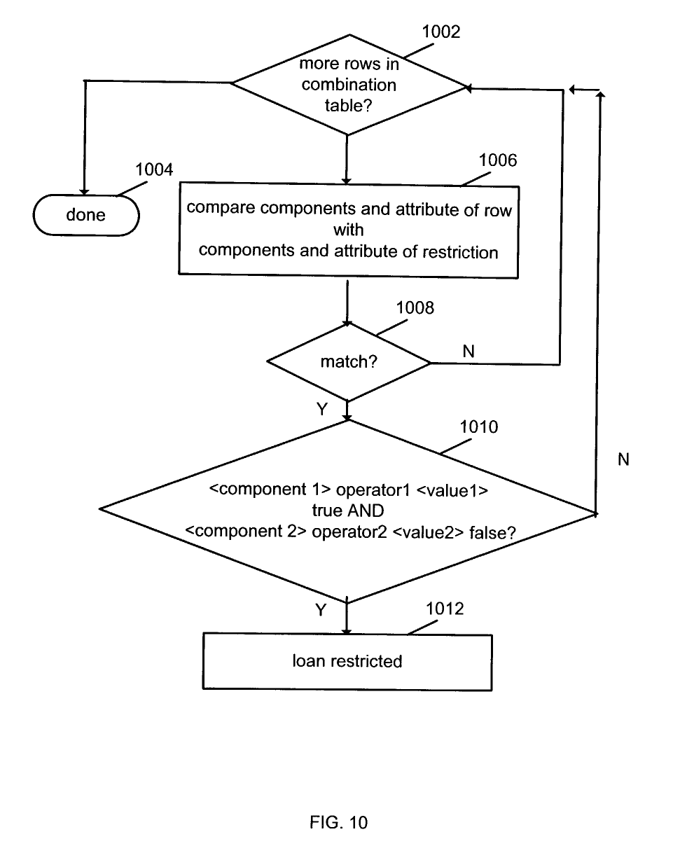

FIG. 10 is a flow chart of a method embodiment to identify loans subject to a complex restriction. At 1002 it is determined whether there are more rows to evaluate in the combination table 702. Typically evaluation will begin at the first row of the table 702, but this need not be the case. If there are more rows to evaluate, the attribute and components of the row are compared with the attribute and components of the restriction at 1006. If at 1008 the components and attribute match, the expression <component1 value><restriction operator1><restriction value1>is evaluated at 1010. The expression <component2 value> <restriction operator2> <restriction value2> is evaluated at 1010. If the first expression evaluates true and the second evaluates false, the loan is identified at 1012 as restricted. Otherwise, the method continues with the next row at 1002. Once there are no more rows to evaluate, the method ends at 1004.

The method may be repeated for each restriction identified by table 202 to identify all complex restrictions that apply to a loan having the attributes and component values identified in tables 502 and 504. When a complex loan restriction is identified as applying to a loan, the complex loan restriction may be communicated in human-understandable terms by applying the syntax previously described for complex loan restrictions.

To identify loans for which simple add-ons apply, each row of table 302 may be evaluated to identify a match with the attributes of table 502. The add-on is applied when a match occurs. This process may be repeated for each simple add-on in table 302 to identify all simple add-ons that apply. When a simple loan add-on is identified as applying to a loan, the simple loan add-on may be communicated in human-understandable terms by applying the syntax previously described for simple loan add-ons.

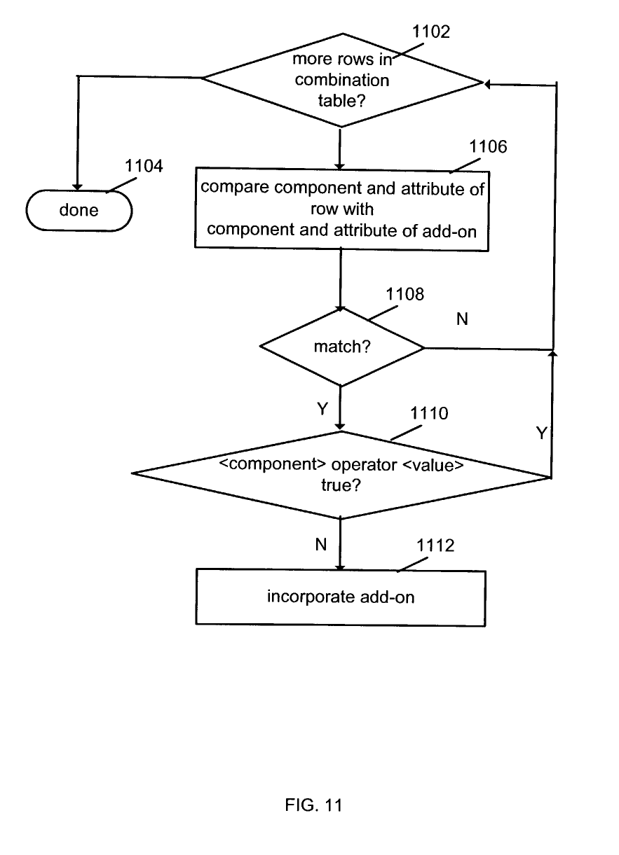

FIG. 11 is a flow chart of a method embodiment to identify loans for which complex add-ons apply. At 1002 it is determined whether there are more rows to evaluate in the combination table 506. Typically evaluation will begin at the first row of the table 506, but this need not be the case. If there are more rows to evaluate, the component and attribute of the row are compared with the component and attribute of the add-on at 1006. If at 1008 the components and attributes match, the expression <component value> <restriction operator> <restriction value> is evaluated at 1010. Otherwise, the method continues with the next row at 1002. If the evaluation is false, the add-ons are associated with the loan at 1012. Once there are no more rows to evaluate, the method ends at 1004.

The method may be repeated for each complex add-on identified by table 402 to identify all complex add-ons that apply to a loan having the attributes and component values identified in tables 502 and 504. When a complex loan add-on is identified as applying to a loan, the complex loan add-on may be communicated in human-understandable terms by applying the syntax previously described for complex loan add-ons.

A “component library” may be provided by each lender, in the form of a set of tables defining loan components. The component library of a lender may be particular to the loan programs available from the lender. For example, a broker may employ a master component library defining a large set of loan programs and loan components for those loan programs. The master dictionary may comprise component descriptions and possibly other supplemental information for all of the loan components. A lender may provide to the broker a component library that is particular to the loan programs available from the lender, e.g. comprising only those components relevant to the loan programs provided by the lender. The particular library may omit the component descriptions and other supplemental information available in the master library. The particular component library may thus be more compact than the master library and may thus be more suitable for communication over voice and/or data networks between the broker and the lender.

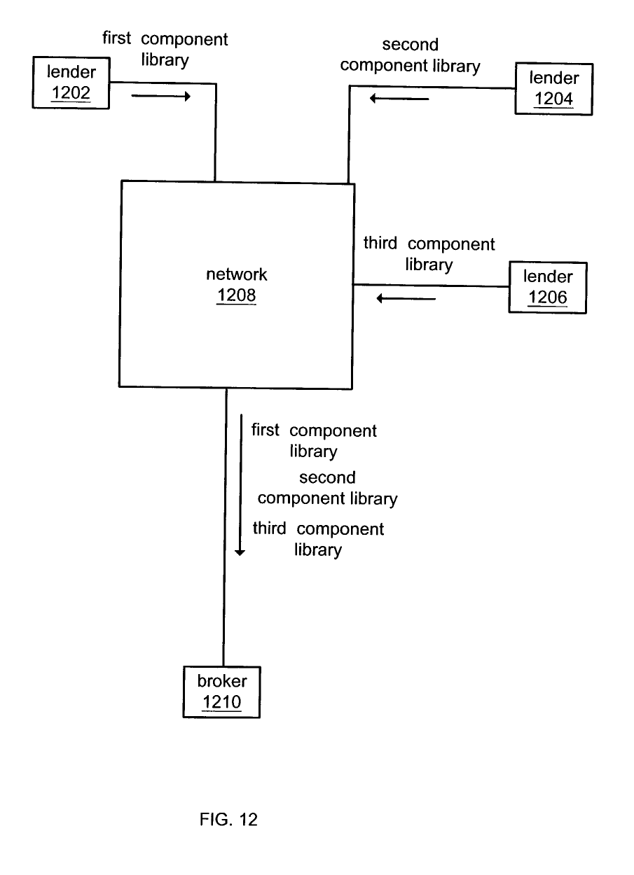

Loan code restrictions and add-ons for a particular lender may then be evaluated according to the definitions of the component library for the lender. The lender may provide rate information and the definitions of calculations for calculated loan components. FIG. 12 is a block diagram of an embodiment of a system for evaluating and pricing loans. First, second, and third lender systems (1202, 1204, and 1206 respectively) provide first, second, and third component libraries. The lender systems typically comprise one or more data processing systems (for example, one or a combination of desktop, laptop, server, midrange, and/or mainframe computers). The component libraries are communicated over a network 1208 to a broker system 1210, whereupon they are stored in a memory such as random access memory (RAM) and/or a magnetic hard disk, optical disk, tape, etc. The broker system 1210 may then be employed to evaluate loan programs, including restrictions and add-ons, of the various lenders according to the component libraries for the lenders.

In one embodiment the broker and one or more of the lenders are comprised by the same organization (e.g. systems of different groups, individuals, departments, etc. within a lending institution).

While certain features of the invention have been illustrated as described herein, many modifications, substitutions, changes and equivalents will now occur to those skilled in the art. It is, therefor, to be understood that the appended claims are intended to cover all such embodiments and changes as fall within the true spirit of the invention.

What is claimed is:

1. A method comprising:
a data processing system storing a definition of a loan restriction, the definition of the loan restriction comprising at least one loan component value and loan component attribute;
the data processing system forming combinations of loan component values and loan component attributes of a loan to evaluate and comparing each of the combinations with the at least one loan component value and loan component attribute of the loan restriction; and
the data processing system identifying a restriction on the loan to evaluate when the loan component values and loan component attributes of a combination match the at least one loan component value and loan component attribute of the loan restriction.

2. The method of claim 1 further comprising:
the data processing system storing at least one tables comprising loan component definitions and loan component attributes; and
the data processing system storing at least one tables comprising loan restriction definitions.

3. The method of claim 1 further comprising:
the definition of the loan restriction comprising a loan attribute, a loan component, an operator, and a value for the loan component, the definition of the loan restriction having a syntactic interpretation of “For” <attribute> “,” <component> “must be” <operation> “value”.

4. The method of claim 1 further comprising:
the definition of the loan restriction comprising a loan attribute, first and second loan components, first and second operators, and first and second loan component values, the definition of the loan restriction having a syntactic interpretation of “For” <attribute> “with” <first component> <first operation> <first value> “,” <second component> “must be” <second operation> <second value>.

5. The method of claim 1 further comprising:
the data processing system forming combinations of loan component values and loan component attributes of the loan to evaluate by forming a Cartesian product of a first table comprising loan component values of the loan to evaluate, and a second table comprising loan component attributes of the loan to evaluate.

6. The method of claim 1 further comprising:
the data processing system storing a definition of a loan add-on, the definition of the loan add-on comprising at least one loan component value and loan component attribute;
the data processing system forming combinations of loan component values and loan component attributes of the loan to evaluate and comparing each of the combinations with the at least one loan component value and loan component attribute of the loan add-on; and
the data processing system identifying an add-on to apply to the loan to evaluate when the loan component values and loan component attributes of a combination match the at least one loan component value and loan component attribute of the loan add-on.

7. The method of claim 6 further comprising:
the data processing system storing at least one tables comprising loan component definitions and loan component attributes; and
the data processing system storing at least one tables comprising loan add-on definitions.

8. The method of claim 6 further comprising:
the definition of the loan add-on comprising a loan attribute, a rate, a margin, a cap, and a fee, the definition of the loan add-on having a syntactic interpretation of “For” <attribute> “add” <rate> “to rate,” <margin> “to margin,” <cap> “to cap, and” <fee> “to fee”.

9. The method of claim 6 further comprising:
the definition of the loan add-on comprising a loan attribute, a loan component, an operator, a loan component value, a rate, a margin, a cap, and a fee, the definition of the loan add-on having a syntactic interpretation of “For” <attribute> “with” <component> <operation> <value> “add” <rate> “to rate,” <margin> “to margin,” <cap> “to cap, and” <fee> “to fee”.

10. The method of claim 6 further comprising:
the data processing system forming combinations of loan component values and loan component attributes of the loan to evaluate by forming a Cartesian product of a first table comprising loan component values of the loan to evaluate, and a second table comprising loan component attributes of the loan to evaluate.
